(19) United States
(12) Patent Application Publication
(10) Pub. No.: US 2007/0206714 A1
(43) Pub. Date: Sep. 6, 2007

(54) Propulsion motor

(76) Inventor: Jose Da Conceicao, Rio de Janeiro (BR)

Correspondence Address: TRASKBRITT, P.O. Box 2550, Salt Lake City, UT, 84110-2550, US

(21) Appl. No.: 11/601,585

(22) Filed: Nov. 18, 2006

Related U.S. Application Data
(63) Continuation-in-part of application No. 11/324,544, filed on Jan. 3, 2006.
Application No. 11/324,544 is a continuation-in-part of application No. 10/528,225, filed on Oct. 31, 2005.

(30) Foreign Application Priority Data
Sep. 19, 2002 (BR) P10205584-8

(51) Int. Cl. H05H 1/22

(52) U.S. Cl. 376/100

(57) ABSTRACT

A propulsion motor is provided to motor and processes, which combined are the nanostructured materials in all motor structures (17, 17A, 18), applied to the reaction room (16), applied to exhaust vessel (13, 14, 15) and in their details, parts of trigger system (1), applied to reaction vessel (2), all with the intention to become less massive, more mechanical resistant, applied to some processes like z-pinch (2, 4, 4A, 4B), high flux compression generator (4, 4A, 4B, 4C, 4D), using ultra super capacitors (4), conductors nanotubes (4A) as well as some parts of CPA laser (2), all with the intention to become less massive, more mechanical resistant and adequate to each situation.

### CROSS-REFERENCE TO RELATED APPLICATIONS

This application is a continuation-in-part of U.S. Ser. No. 11/324,544, pending, filed Jan. 3, 2006, which is a continuation-in-part of U.S. Ser. No. 10/528,225, pending, which is a national entry application under 35 USC 371 of PCT/BR2003/000046 filed Mar. 27, 2003, which claims priority to Brazilian application P10205584-8 filed 19 Sep. 2002.

The instant application is also a continuation-in-part of U.S. Ser. No. 10/528,225, pending, which is a national entry application under 35 USC 371 of PCT/BR2003/000046 filed Mar. 27, 2003, which claims priority to Brazilian application P10205584-8 filed 19 Sep. 2002.

The instant application also claims priority under 35 USC 119 to Brazilian application C20205584-8 filed Nov. 18, 2005.

U.S. Ser. No. 11/324,544, noted above, claims priority under 35 USC 119 to Brazilian application C10205584-8 filed Jan. 3, 2005.

All of the above referenced applications are hereby incorporated by reference in their entireties.

### TECHNICAL FIELD

It is an improvement in materials relative to motor structures, contention vessel of explosions and materials used in heat exchanges where needed, in the magnets constitution where needed, nanotechnology being extended to all functions that need their mechanical, electrical, thermal and optical properties from materials or nanostructured materials, including metals, ceramic alloys, polymers or varieties of super-plastics, or carbon nanocomposites, mainly carbon nanotubes forming or not of bulk nanostructured materials.

### BACKGROUND

The mass necessary in the compression laser system for fuel target in nuclear fusion is a big problem responsible by 150 to 200 ton of mass, more than the mass needed in the magnets around the exhaust vessel and in the first wall refrigeration system and material related to these layers, and in the protector layer where needed, and in the reactions vessels, responsible for more 600 ton of mass.

In 1985, the fullerene molecules like C₆₀, after C₇₀, etc., were discovered to be one of new carbon formations beyond graphite; but only in 1990, the mass production of these substances was achieved.

In 1991, the carbon nanotubes were discovered, forming carbon nanofibers, considered in that time, as the beginning of a big fullerene; but only in 2001, these materials were considered to be applied to metals, fusing together, by many techniques, carbon nanotubes with certain metals, alloys, polymers or ceramics or nanocomposites to form tree dimensional structure materials when the nanotubes grow (are formed). This production method of nanotubes associated (fused) to nanostructured materials referred to in this paragraph and in the present invention, has U.S. patent application Ser. No. 60/474,925 filed Jun. 3, 2003.

In 1995, nanomachines, nanosensors were already considered, upon purification and mass production, the study of physical properties of nanostructures (fibers, tubes, fullerene), their classification, etc., has begun. In 2001/2003 the metal industry claim a revolution in advanced materials like in bulletproof vests, as well as in the metallurgy, with nanostructured bulk metals like in metal sheets, tubes, etc., like in nanofluids, as well as nanotechnology applied in known high explosives.

With the advances obtained now by nanotechnology in many search areas, can extend the use of this materials in contention vessel of explosions, like in motor and laser structures being reduced drastically the motor mass, justifying compression laser structures and laser fast ignition that need the contention vessel and with some ton of mass with high toughness strength and easy to be transportable and substituted after a cycle.

Grain is a key word in severe plastic deformation technology (SPD) which imposes very large shear strains in metals under moderately high pressure, but without change external dimensions of the metal, and the process, imposing more deformations each time. The shearing strain generates many additional dislocations were every microscopic volume within the metal to undergo rotation. New internal interfaces, or grain boundaries, that enclose progressively smaller number of atoms.

Smaller the grain result in greater strength and other mechanical properties, following the classical Hall-Petch relation for grain size 15 nm and large, under this value, materials loose their properties.

One of the benefits of nanostructured materials is the ability to impart strength level in pure metals that exceed the level of alloys. Also, grains of ultra-fine size create prospect of super-plastic forming at lower temperatures and higher strain rates than are possible with conventional alloys, and many applications are found to nano-ceramics, and nano-polymers relative to present motor, like coating, refrigeration, thermal isolation, electrical conductors best than common copper, heat exchange systems with smaller mass, or like bulk nanostructured magnets, that are more compact and has great coercitive force. To welding systems in bulk materials by agitation and friction and high strength fissure resistant, that is a crucial problem in this technology, metal lamina or ceramics like a shield or coating, nuclear explosive containment, structural motor component, like associate spaceship structures which benefits from mechanical, electrical, thermal and optical properties associate with carbon nanotubes, carbon nano fiber or nanostructured bulk metals obtained by SPD, fused carbon nanotubes, nanotubes from carbon aerogel, laser ablation, CVD, sol-gel, or any other method to obtain nano materials, nano crystals, nano grains, nano particles, applied or not, to bulk materials that constitute the motor and processes.

Carbon nanotubes are typically 7 to 1000 times more electrical conductive than superconductor to common copper.

Ten years ago in the technology of explosion contention vessels, models with ray 2.6 m that support 450 kg TNT equivalent, but made from steel 7.8 g/cm³ of density, like an example, giving 70 ton of mass in spherical geometry and 34 ton of mass in cylindrical geometry, needing according model 4 or 2 reaction vessels. How we can observe are values relatively high with materials from patent application Ser. No. 10/528,225 and with exception of the first wall from patent application Ser. No. 11/324,544 and in the tubes and sheets of contention from magnet stress, the other materials where needed a reactor to make the laser. The most simple manner, without compression laser structures, in the exhaust vessel only has the super high chemical explosive that detonate U/Pu and DT, generating many neutrons in the explosions and in a vessel of (5 m×5 m) hemispherical dimensions from nanostructured carbon of density 3.5 g/cm³ and 10 cm thickness and has around 52 ton of mass. A reasonable value if need only the first wall, but with U/Pu and DT produce many neutrons from explosions, needing a refrigeration layer, heat exchange system, neutron protector layer, magnetic field layer, adding laser system (from mW to MW of power) to trigger super high explosive lenses, with 100 ton of mass and with materials from continuation-in-part Ser. No. 11/324,544 give a reasonable quantity of mass more than 340 ton of mass, without materials need in processes, like in table 2 (12 times Jumbo mass or Jumbo weight).

### SUMMARY OF THE INVENTION

The finality of present invention is to solve the above problems, particularly the materials used in above cited before patent applications.

To made the same before first wall using a material from nanostructured carbon (carbon nanotubes—CNT) of density only 0.3 g/cm³ the wall mass is 5.8 ton and subtracting the magnetic field layer in explosions containing only DT and material with this density is very porous then is possible nanotubes that conduct nanofluids, water, lithium, or another traditional fluid used in heat transfer, containing metal nano particles (Cu, etc.), or high conductivity ceramics immersed in fluids with 2000 m²/g, another methods use some fluid and nano particles of Cu or CuO immersed in a work fluid like in U.S. Pat. No. 6,221,275 filed Apr. 4, 2001 or still silica oxide(SiO₂) or titanium oxide(TiO₂) to alter the conductivity of liquid state. This is made because solid particles conduct heat best than liquids, and nano particles has high superficial area 1000 times greater than micro particles and stay suspended in liquids and smaller nano particles best, and with only one material fulfill two jobs (refrigeration and fluid transport) and resultant density of nanostructured material 1.5 g/cm³, remaining with this processes 30 ton of mass, in 10 cm of thickness is possible to made many nanotubes and using carbon nanotubes with graphite matrix or matrix from nanostructured ceramic material like neutron protector layer, remaining around 40/45 ton of mass with all refrigeration functions what is a novelty and advantage and adding the mJ energy laser system with 10 ton of mass, remaining with this processes 45/55 ton of mass what is a novelty and advantage, being the more light model without magnetic field layer, what if need, and with nanostructured material adding more 45 ton of mass, remaining 90 ton of mass in the motor, may be possible 60 ton of payload.

For fast ignition systems with materials from before patent applications the compression laser mass and the fast ignition laser mass is high join exhaust vessel mass. A innovation in this way is eliminate the massive compression laser system and substitute by super high explosive (SHE) compression or nanostructured chemical high explosive, that explosive lenses system can be triggered by less massive lasers, using for U/Pu compression (best nanostructured high explosive produce 10 kJ/g, using 100 g produce 1 MJ of energy—in ICF search the compression laser has 10 kJ) and after in the inner DT shell hit by fast ignition laser with explosions in the contention vessel, and the before target direct in the exhaust vessel, but the specific impulse is less, only for interplanetary travel, being this a system of intermediary mass by fuel trigger beam, with material from present invention applied to motor and processes.

In the technology of contention vessel of explosions get 4.2 GPa was an advance, which surpass significantly in magnitude the strength of quenched steel, obtained by glass fiber reinforced plastic has allowed to design light vessels that withstand up to 200 kg of TNT equivalent, this in 1995.

The finality of present invention is the utilization of materials like metal, ceramics, polymers nanostructured (constituted from carbon nanotubes associated with super-plastic materials like glass alloys) in the contention vessels of explosions (in cylindrical, spherical, and hemispherical geometry) that will made the fast ignition laser and greater the vessel greater the explosion and greater the energy for fast ignition laser formation and with this use advanced fuel in the exhaust, that in this case, has the advantage of not need the neutron protector layer, only first wall (constituted from high specific area material to disperse heat, besides that, the nanotubes being made like optical fibers with long extension, in the exhaust vessel dimensions) and the refrigeration nanofluids (like defined above) inlayed in the nanotubes (today is possible transport water in carbon nano pipes with the help of bipolar electrochemical—bipolar electrodepositing) and the layer of bulk nano magnets of copper and carbon, more compact and light and density of 2.9 g/cm³ that is a novelty and advantage. Made a vessel of (3 m×3 m) contention of explosions and with CNT (carbon nanotubes) of density 0.3 g/cm³ and the vessel in cylindrical shape directed to target, since the laser radiation arrive the target first than plasma fragments, if the vessel is open, and more than 1.8 ton of mass remaining 7.2 ton of mass the four vessels, adding the mass layer of magnets, remaining according following tables and various models and materials, and in all cases the thickness is 10 cm and adding the values of common materials in table 2, like steel, glass alloys, vitralloy (Vit1) and some ceramics alloys (carbide) the mass motor in this case is around 800 ton of mass with structures payload values and neutron protector, graphite like common material and carbon nanostructured as new material. Adding the values with nanostructured material exemplified by ns-C (carbon nanostructured), since can contain nanostructured metals, alloys or combinations of polymers and ceramics, or still carbon nano composite, and in this case the mass motor is 270 ton of mass (5 times de A380 mass) more light than is supported by a vessel of (5 m×5 m) around 800 ton of mass allowing a vessel of smaller size, diminishing still more the mass of all motor. Note too, that ion compression using common materials need 100 ton, and with nanostructured materials need 50 ton of mass, see table 2.

The compression laser system can be very light, since the laser energy is in the mJ, or mW to MW of power, 10 ton of mass made of nanostructured materials according explosive used, for after trigger the chemical high explosive in the constitution of nuclear target, direct in the exhaust vessel, like in table 2, remaining between 50/120 ton of mass, removing some layers (50 ton case) with advanced fuel, and using an exhaust vessel of (4 m×4 m) from 17 ton of mass supporting 0.5 ton TNT equivalent impelling 500 ton of mass with a good security margin, without need reactions vessels, therefore in this case is adding 5 ton of mass according table 1, remaining 40/0.50 ton of mass, pending on first wall material nt-C (carbon nanotubes or buckytubes), to be smaller dense of all, comparable with ns-C (nanostructured carbon), that is a novelty and advantage.

The first four lines from table 1, due to explosions dimensions can be initiated by z-pinch, array-zpinch, fast z-pinch with compression by chemical super high explosives (SHE), high compression flux generator, MTF, etc., using super capacitor in this processes, that is capacitors made from nanostructured material, producing more compact systems that need smaller mass and has greater energy density or ultra super capacitors (capacitors from carbon aerogel with specific area of 800 m²/g, allowing capacitors until 100° F.), using still superconductors films, or nano superconductors, transporting more quantity of current, or by methods like hydronuclear tests for radiation generation and made a laser, and after detonate fusion fuel in the exhaust.

TABLE 1
Contention vessels models

| | | | | | refrigerator | explosion | explosion |
|---|---|---|---|---|---|---|---|
| | density | | | | mass pump/heat | energy | energy |
| Substance | g/cm³ | dimensions | mass | | exchange | no isomer | with isomer |
| nt-C | 0.3 | 50 cm × 50 cm | 49 | kg | no nano fluid | 0.0001 | 5.5 MJ (gain |
| ns-C | 3.0 | | 490 | kg | nano fluid | ton TNT | of 10) |
| Vit1 | 5.9 | | 950 | kg | 270 kg + 200 kg | or 740 kJ | |
| Steel | 7.8 | | 2 | ton | 270 kg + 200 kg | | |
| nt-C | 0.3 | 1.20 m × 1.00 m | 120 | kg | no nano fluid | 0.001 ton | 55 MJ (gain |
| ns-C | 2.4 | | 960 | kg | nano fluid | TNT | of 10) |
| Vit1 | 5.9 | | 2.4 | ton | 1 ton + 0.5 ton | or 7.4 MJ | |
| Steel | 7.8 | | 2.9 | ton | 1 ton + 0.5 ton | | |
| nt-C | 0.3 | 2.60 m × 2.60 m | 1.3 | ton | no nano fluid | 0.005 ton | 260 MJ(gain |
| ns-C | 3.5 | | 14 | ton | nano fluid | TNT | of 10) |
| Vit1 | 5.9 | | 26 | ton | 7 ton + 1 ton | or 37 MJ | |
| Carbide | 6.1 | | 26 | ton | 7 ton + 1 ton | | |
| Steel | 7.8 | | 34 | ton | 7 ton + 1 ton | | |

TABLE 2
Mass option need in the motor (hemispherical vessel)

| | | | | | | energy | |
|---|---|---|---|---|---|---|---|
| | | | | | | in the | impelled |
| Function | substance | density | dimensions | mass | | explosion | mass |
| Exhaust vessel | ns-C | 3.5 | 5 m × 5 m | 52 | ton | 800 kg | 800 ton |
| Exhaust vessel | nt-C | 0.3 | | 6 | ton | TNT | of mass |
| Exhaust vessel | steel | 7.8 | | 125 | ton | or | |
| Magnetic Field | mat. nano | 2.9 | | 45 | ton | 0.8 ton | |
| Magnetic Field | struc. | 8.4 | | 140 | ton | TNT | |
| Neutron protector | steel/iron | 1.4 | | 23 | ton | | |
| Neutron protector | mat. nano | 2.1 | | 33 | ton | | |
| Laser | struc. | ? | | 80 | ton | | |
| compression | graphite | ? | | 200 | ton | | |
| Laser | mat. nano | | | 50 | ton | | |
| compression | struc. | | | 100 | ton | | |
| Ion compression | common mat. | | | 10 | on | | |
| Ion compression | mat. nano | 0.08 | | 5 + 1 | ton | | |
| Laser comp. (mJ) | struc. | 0.53 | | 8 + 5 + 1 | ton | | |
| Refrigerator | common mat. | 7.8 | 1.20 × 1.00 m | 12 | ton | | |
| Refrigerator | mat. nano | 3.0 | | 2 | ton | | |
| Reaction vessel | struc. | 7.8 | | 20 | ton | | |
| Reaction vessel | nano fluid | 3.0 | | (80 | ton) | | |
| Payload/structures | lithium + heat | | | 10 | ton | | |
| Payload/structures | exch. | | | (30 | ton) | | |
| | steel | | | | | | |
| | mat. nano | | | | | | |
| | struc. | | | | | | |
| | steel | | | | | | |
| | mat. nano | | | | | | |
| | struc. | | | | | | |

Fused by many techniques carbon nanotubes with some metal, ceramics, were in many situations are carbides in general and in the motor structures are ideal silicon and boron carbides used in armor, or polymers forming tree dimensional structures when the nanotubes are made (grown).

By this method a single wall of carbon nanotube (SWNT) based composite have demonstrated energy of rupture 20 times of that Kevlar based composites, or still that the high strength associated with nanotubes, about 100 times the tensile strength of steel (σ) at ⅙ of mass, being this one of methods that produce a material of high strength and high elasticity limit, i.e., 200 GPa to 1 TPa of strength, therefore theoretical calculations show values until 10 Tpa, and from to 5% and 10% of elasticity limit, ideal conditions to build a contention vessel of explosions or exhaust vessel. This is so important that if applicable to all motor and structures, reduce, for example, from 1200 ton of mass to 200 ton of mass, and can made a little explosion of 0.2 ton TNT equivalent in the exhaust to impel until 300 ton of mass (comparable to 8 aircraft 747) and elaborate a test probe. Today is possible high strength steel reinforcement wire (207 GPa) forming more light structures for armor, or metal sheets with nanostructured bindings in these points of torsion, but with steel the density is high. With carbon nanotubes with the thickness of a hair can easily sustain a locomotive, due to mechanical properties.

To build a nuclear explosive reaction vessel, the material dynamic is that has median Young modulus (Y), high capacity to absorb energy (G_{ic}) and a high value of strength (σ), i.e., a bulk nanostructured super-plastic, since the material was very stiffness not expand enough and after return to initial position. With this parameters we can calculate the minimal vessel ray of material constitution to tolerate instable fracture, that for antinodes in spherical geometry obey the condition of not fracture, inequality (1):
∫_{V}qdv>∫_{S}G_{ic}ds (1)
where V=(4/3)πR²h, S=2πRh(2n)^{1/2} and q=σ² (1−ν)/E
   R=3(2n)^{1/2}YG_{ic}/2σ²(1−ν) (2)
   For a thin spherical vessel n=2.12(R/h)^{1/2}−0.5: where R is around 5 m and the thickness 0.1 m like an example, giving an n=14.6 and the R is in equation (2): R=8.1YG_{ic}/σ²(1−ν)(2′).

For nanotubes ν is between 0.2 e 0.3 and Young modulus around 1.8 TPa, σ=200 MPa ad G_{ic} from nanotubes is low 400 J/m² and the vessel ray is 6 m. But with nanostructured materials we can use a binder or matrix (fused nanotubes, substrate, CVD, therefore the quality of nanotubes depend from various factors: purity, method of production, defects, etc.) with materials that has high G_{ic} (glass alloys or super-plastics) and with this to weave bulk nanostructured materials with the following characteristics; Y=1.2 TPa, σ_{y}=400 Mpa, ad G_{ic}=4.104 J/m² and the vessel ray is 3.6 m using the equation (2) above, a vessel ray greater than made from steel (2.6 m) in the vessel constitution, but with very smaller mass. In a hemispherical vessel, assuming q half value from spherical case and using the antinodes from spherical case, i.e., an area of S=2πRh(2n)^{1/2} and hemispherical vessel volume V=2/3πR²h, and substituting in inequality (1) find to vessel ray a value 2 times greater than spherical case and verify that the vessel ray depend on fracture mechanical properties. This is the moment to analyze about the laser way orifice in the spherical vessel or cylinder, and if is admissible in terms of fracture if the vessels are closed, and the laser diameter is around millimeter, that is the magnitude acceptable in fractures mechanics, and area of this orifices has a reinforcement, that is a common practice in the construction technology of explosive vessel containment, and the vessel can be substituted after a cycle.

Carbon nanotubes and copper, with thermal conductivity of 1300 W/mK, ideal for cylindrical tube that will transport the work fluid, like in the heat exchange. Carbon nanostructured can allow super capacitors with greater storage energy capacity from carbon films or carbon aerogel and due to high specific area around 800 m²/g and high electrical conductivity, i.e., a large number of charge in a large surface (½ qV) and many of this capacitors can be linked in parallel adequate for high flux compression generator system or z-pinch systems to obtain little nuclear explosions with the intent to laser formation. In the vessel of contention or reactor made from carbon nanostructured from nanotubes, nanofiber, nanocomposites, etc., with density above 0.3 g/cm³ and 10 cm thickness a cylinder (2 m×2 m) remaining 800 kg of mass to retain explosions 0.002 ton TNT equivalent, around 15 MJ of energetic x-rays to made the laser, that is a novelty referenced to provisional patent application Ser. No. 10/528,225 and continuation-in-part Ser. No. 11/324,544 from before application or still a vessel of (3 m×3 m) remaining 1.8 ton of mass and supporting until 0.01 ton TNT equivalent around 80 MJ of energy to made the laser. Is possible nanostructured material of mix density linking the nano carbon to nano composite forming bulk nanostructured materials and the mass changing with density and thickness, being still lighter.

Nano magnets (materials constituted from Fₑ, Nᵢ, Cₒ) obey the Hall-Petch general relation, but if need magnetic fields more than 30 T, then are need 1 nanometer grain size, but in this size occur inverse Hall-Petch effect. Due to this some materials can be associated with a binder or matrix and fused by carbon nanotubes and then produce nanostructured materials with desired strength. With copper for example, and know that copper nanotubes support high magnetic fields without happen fractures forming stiffness copper based material with 100 nm thickness has 900 MPa and with 10 nm thickness 2.9 GPa, beyond another materials.

Will need in present invention two types of pulsed magnetic field; not destructive (in the vessels), destructive (in z-pinch and correlates) being their capacitor up graded to ultra super capacitors (capacitors from carbon nanostructured aerogel with specific area of 800 m²/g) using still nano conductor or nano super conductors (superconductors films, that occur when nano particles are deposited in superconductors), nanostructured high explosives in the armature of high flux compression generator and adding all this advantages to gain a factor of 10 from actual technology and can attain magnetic fields of 3000 T to 6000 T, since present capacitors the energy is around 10 kJ until 4 MJ and in the ultra super capacitors energy storage in the 10 MJ, where the aerogel made the electrochemical double layer capacitors and electrodes, many then linked in parallel.

Other option for pulsed not destructive magnetic field like molecular nano magnets, in most of the cases, nano crystals from iron or nano grains deposited in a hard matrix. For not destructive pulsed fields we can include materials with stiffness like Fe₇₉Nd₇B₉ that has magnetic fields around 10 T forming nanostructured magnetic materials, where the coercitivity control is made thorough parameters that govern magnetic anisotropy, composition and structure. According table 2, and the above description, we can verify that many options of exhaust vessels can be elaborated, according to motor layers and processes covered in the present invention.

### DESCRIPTION OF THE DRAWINGS

The present invention will be better understood thorough following detailed description in consonance with annexed drawings.

FIG. 1. Show the internal and external motor parts referenced to patent application Ser. No. 10/528,225 that will be from nanostructured materials, or bulk nanostructured materials.

FIG. 2. Show the motor structures referenced to patent application Ser. No. 10/528,225 (laser, magnets, protector layer, reaction or contention vessel, etc.) that will be from nanostructured materials or bulk nanostructured materials.

FIG. 3. Show parts of motor and reactor structures, referenced before patent application, in this geometry, that will be from nanostructured materials or bulk nanostructured materials.

FIG. 4. Show parts of motor and reactor structures, referenced before patent application, in this geometry, that will be from nanostructured materials or bulk nanostructured materials.

FIG. 5. Show parts of motor and reactor or reaction room structures, referenced before patent application, in this geometry, that will be made from nanostructured materials, or bulk nanostructured materials.

FIG. 6. Show parts of motor and reactor or reaction room structures, referenced before patent application, in this geometry, that will be made from nanostructured materials, or bulk nanostructured materials.

FIG. 7. Cylindrical vessel reactor, where initiate and support explosions referenced to before patent application, with modified dimensions.

FIG. 8. Show parts of motor and reactor or reaction room structures, and laser from mW to MW of power referenced before continuation-in-part patent application, which will be from nanostructured materials or bulk nanostructured materials.

FIG. 9. Show parts of motor and reactor or reaction room structures and CPA laser referenced in before continuation-in-part patent application, which will be from nanostructured materials, or bulk nanostructured materials.

FIG. 10. Show parts of motor and reactor or reaction vessels structures of nuclear boosted explosive referenced in before continuation-in-part patent application, which will be from nanostructured materials, or bulk nanostructured materials.

FIG. 11. Show parts of motor and reactor or reaction room structures in z-pinch systems referenced in before continuation-in-part patent application, which will be from nanostructured materials, or bulk nanostructured materials.

FIG. 12. Show parts of motor and reactor or reaction room structures and solution relative to magnetic field stresses, where the magnets will be from nanostructured materials, or bulk nanostructured materials.

FIG. 13. Detail from z-pinch, triggered by super capacitors bank and reaction room and transmission line, which will be from nanostructured materials.

FIG. 14. Detail from high flux compression generator, which will be from nanostructured materials.

### DETAILED DESCRIPTION OF THE INVENTION

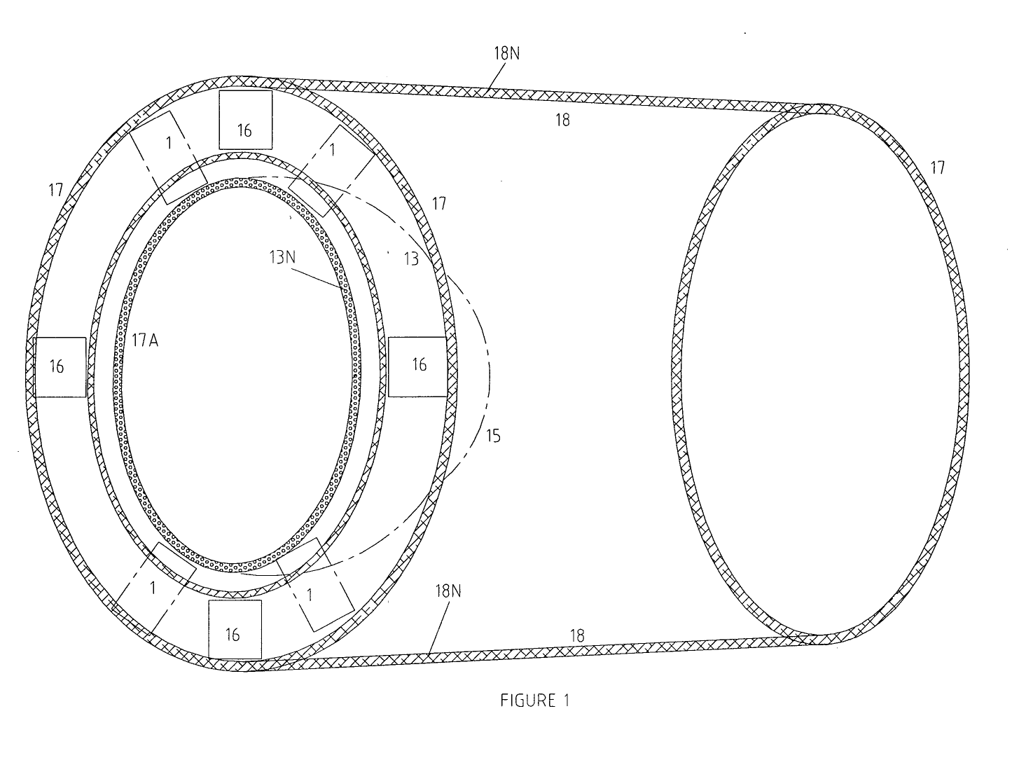

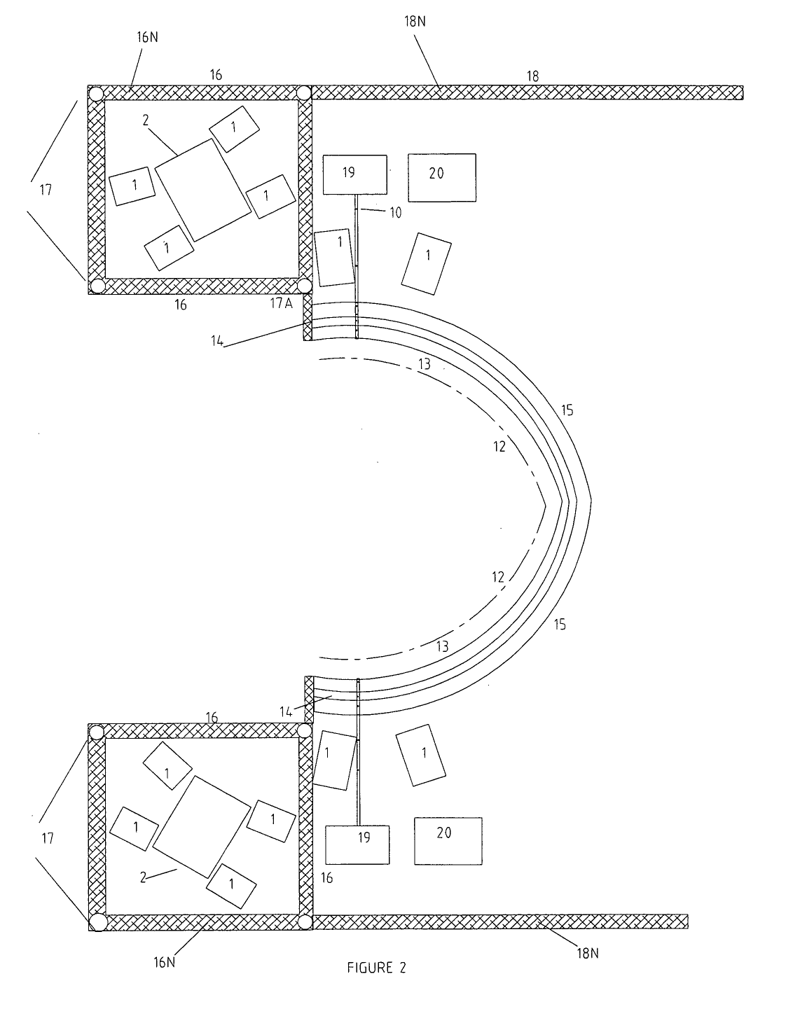

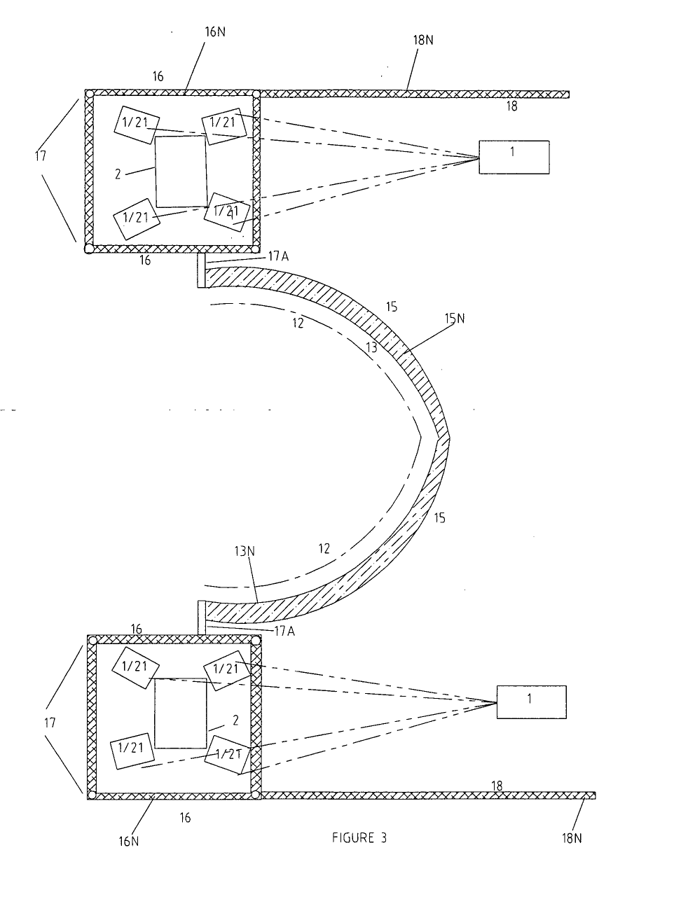

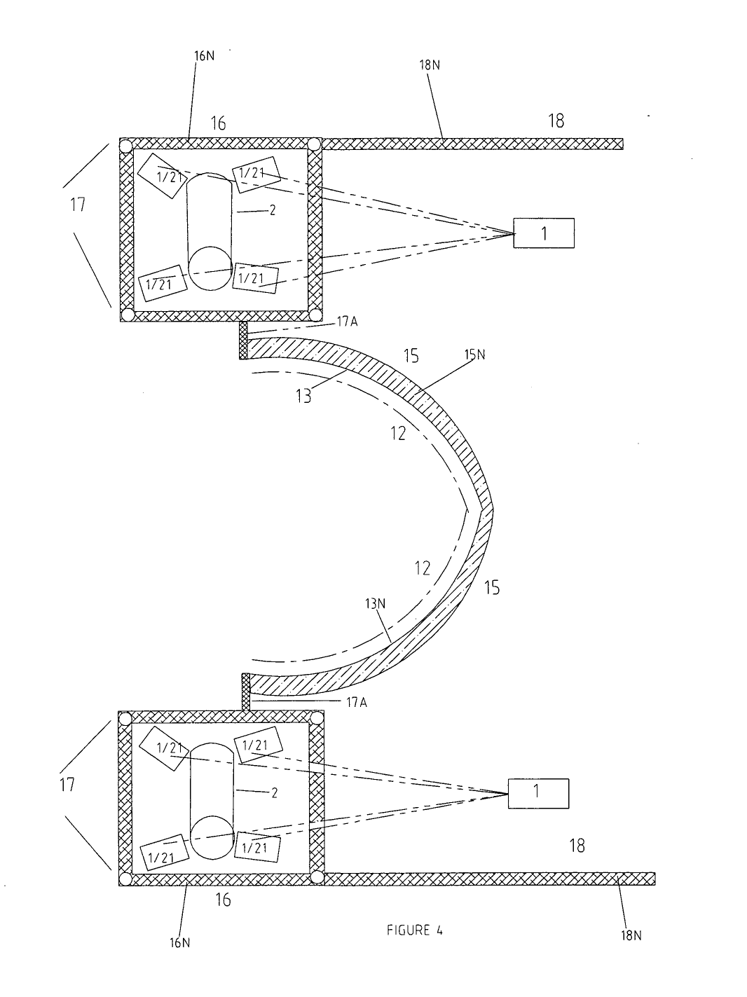

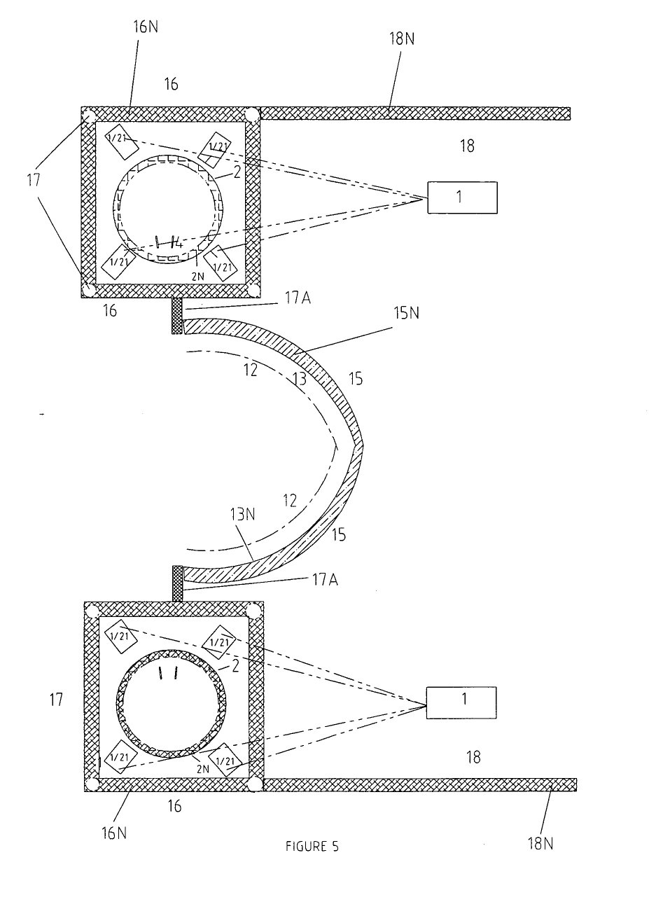

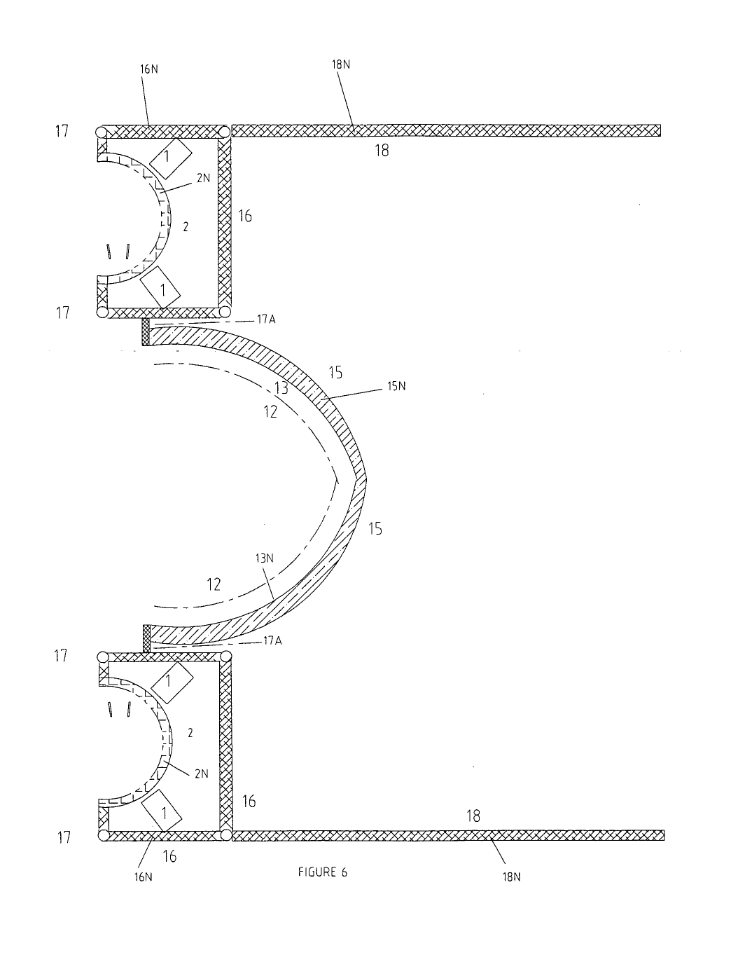

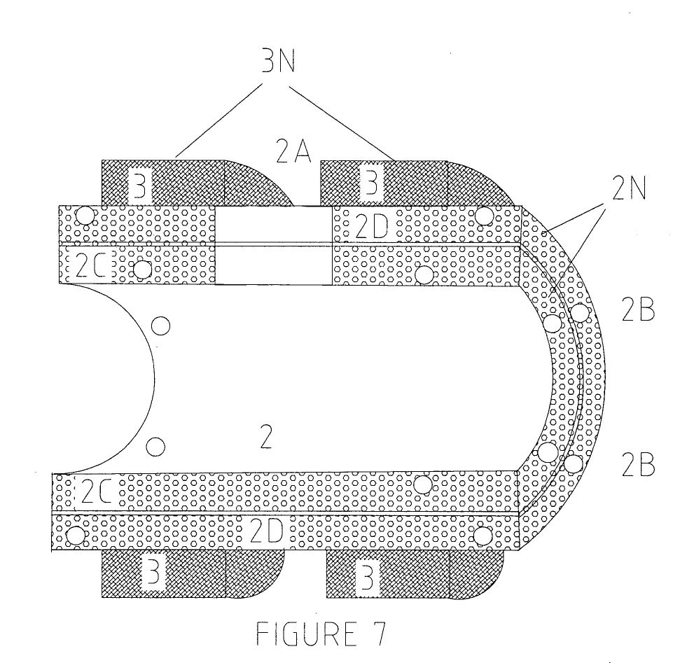

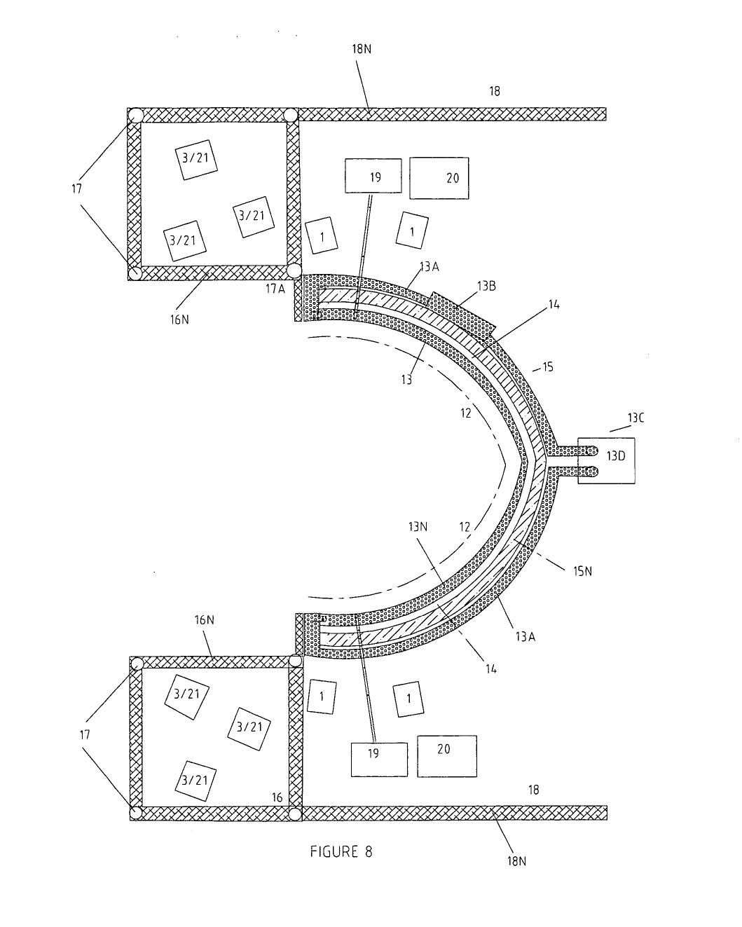

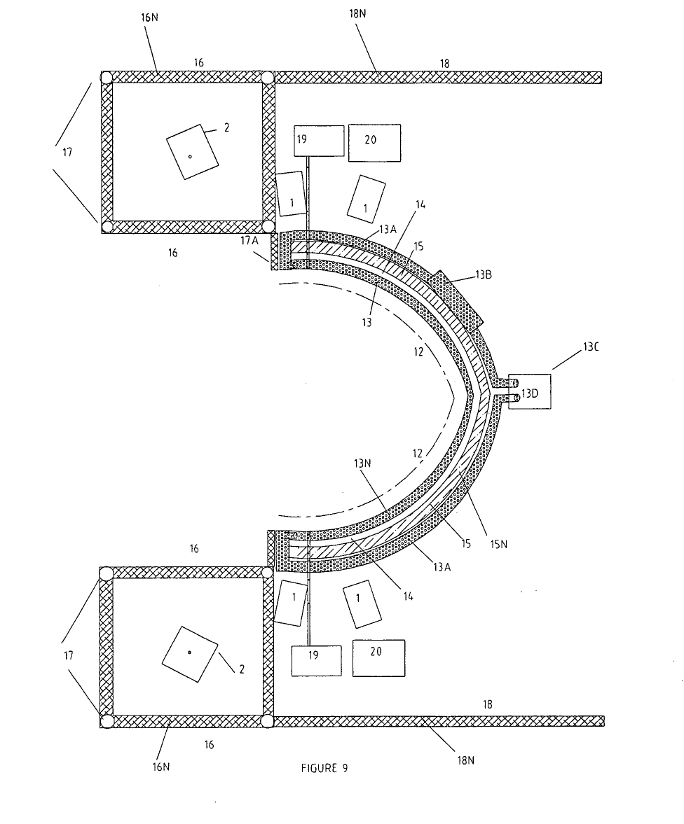

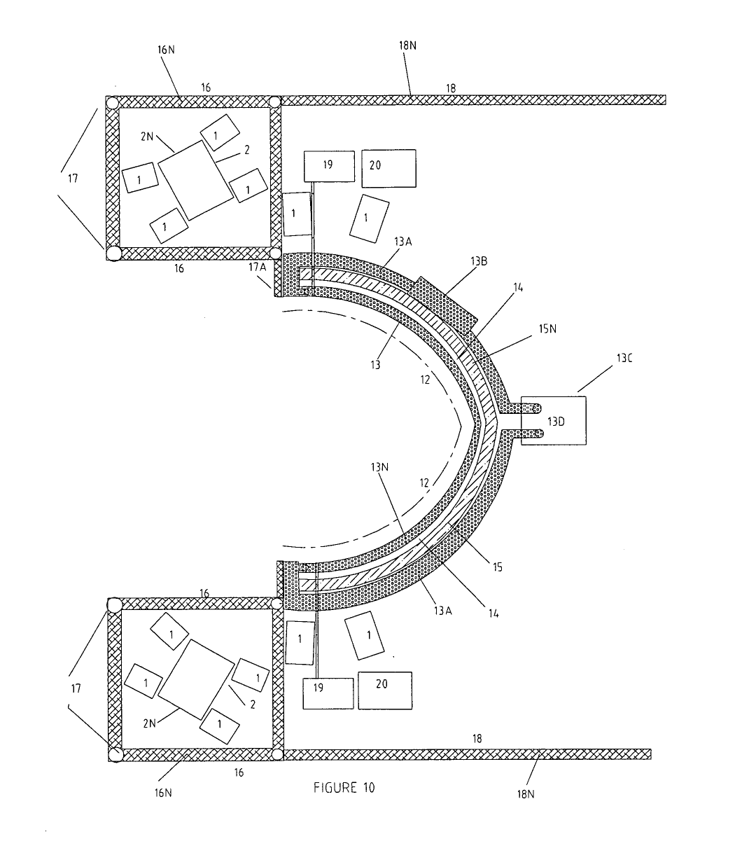

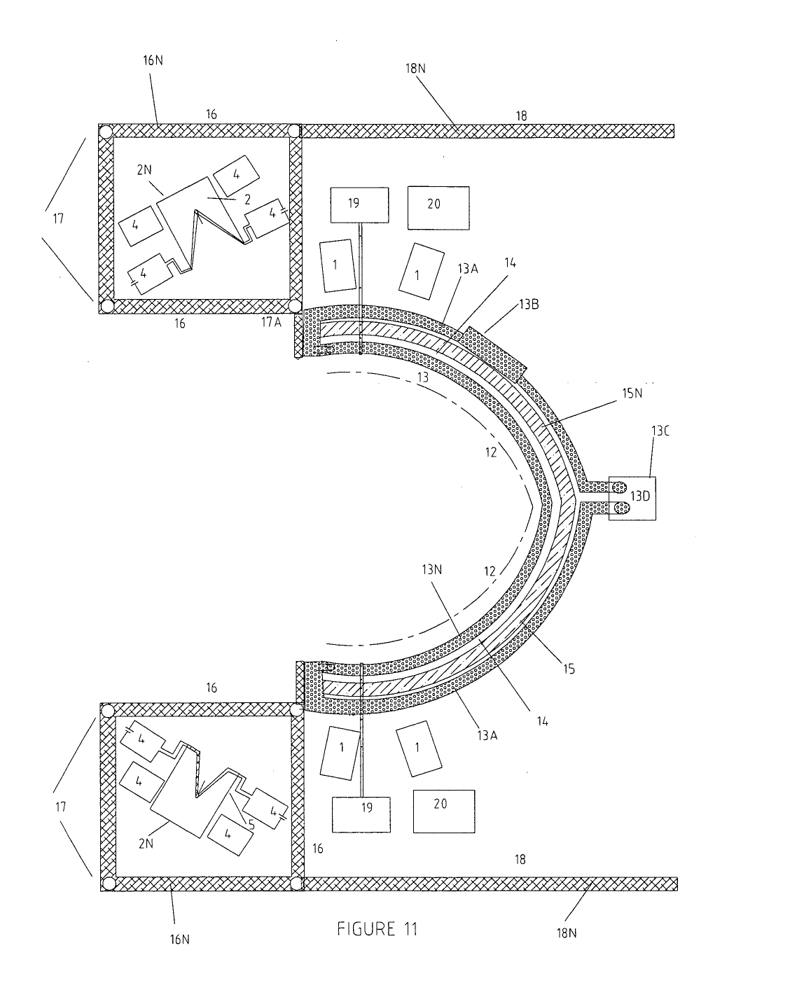

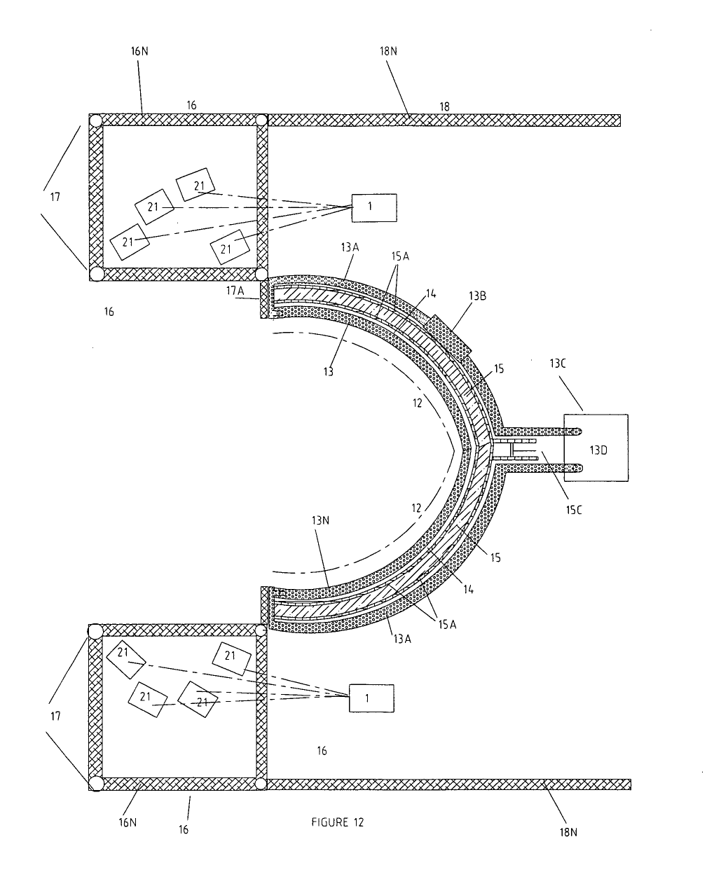

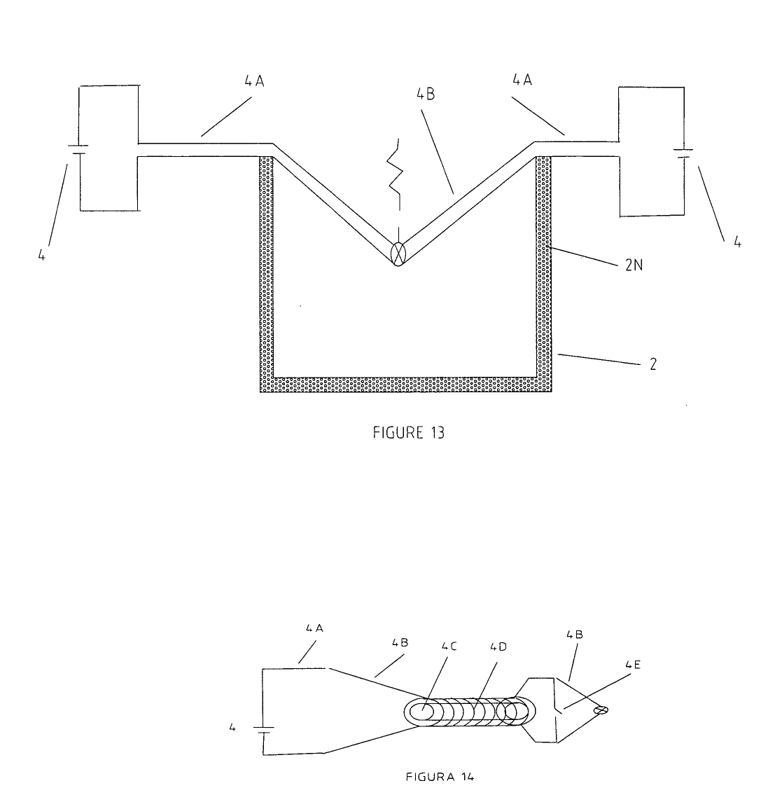

According with this drawings and in their details the present invention “PROPULSION MOTOR”, has the internal and external motor structures according FIG. 1, that is, from number (14) until number (18) and the parts relative to laser (1)(laser gun, amplifiers, compressors, etc.), that will be from nanostructured materials, with exception from first wall (13), being in present invention from carbon nanotubes (nt-C or buckytubes) (13N) since referenced with before continuation-in-part patent application was altered to carbon-carbon nanostructured. When need the refrigerator system (13A) this being from nanofluids, and second computer simulations using molecular dynamics or lattice Boltzman, among others simulation methods, can be allowable, with temperature control, or external force applied, fluid transport characteristic, that is need in the present motor, less quantity of fluid and less dense, not needing practically fluid storage (13C) in some cases, but of a little reservoir for a bulk nanofluid pump (13D). The heat exchange (13B), with nanostructured materials, is made among heat dissipation by nano material from high specific surface, which can dispense the reasonable volume of conventional heat exchange. The protector layer (14) where needed, is constituted from nanostructured ceramic material, being more light and resistant, or a combination of some metals with nanostructured ceramic materials, forming then bulk nanostructured materials. The next layer (15), needed in models with advanced fuels for the magnetic field repel reaction products from nuclear explosions, well like maintain the hot plasma away from first wall (13) being best to temperature control, since mechanical properties of carbon nanotubes are sensible to temperature variation, being the magnets from magnet nanofluid or bulk nanostructured magnets (15N) reducing many times the magnet mass in the processes, that is a novelty and advantage. With reaction vessel (16) a bulk nanostructured material or carbon-carbon nanostructured material (16N) with some cm of thickness and with high resistant to failure or a combination of nano metals and nano polymers. But with carbon nanotubes (nt-C or buckytubes) materials with smaller density and more resistant are allowable. Still in FIG. 1, referenced to external motor structures (17, 17A, 18) being constituted from nanostructured materials of metals, like titanium, molybdenum, aluminum, polymers, fibers (carbon, Kevlar, nextel), ceramics or combinations of this materials, besides carbon nanostructured, that can be more light. In continuation-in-part patent application the tubes or sheets (15A) to maintain the magnets (15) together are from nanostructured materials, show in FIGS. 8 to 12, and much more light in FIGS. 1 to 6 from present invention. In FIGS. 2 to 6 what change is the geometry of contention vessel or reactor, according each case, being constituted from nanostructured materials. In FIG. 7 what change are structures (2) from contention vessel or reactor constituted from carbon-carbon nanostructured, carbon nanotubes (2N) or nanostructured polymers or ceramics of nanostructured materials with 12 cm of thickness in cylindrical, spherical and hemispherical geometry, that correspond to FIGS. 2 to 6, and the layer (3) from magnets (3N) where needed in reactor vessel (2) that will be constituted from nanofluids or bulk nano magnets materials based on (Fe,Nd,B) that produce fields around 10 T. In FIG. 8, where the laser (1) that detonate explosive lenses direct in the exhaust (13, 14, 15) are relatively light, but has some parts of nanostructured materials and the part relative to first wall refrigeration (13), the work fluid (13A) constituted from nanofluids that circulate inside first wall (13) that in continuation-in-part patent application is of nano materials. Heat exchange (13B) constituted from nano materials of high heat dissipation surface, like copper and carbon nanotubes needing a smaller storage fluid tank (13C), we can say that the heat exchange (13B) and the fluid storage (13C) are joined, and the fluid pump (13D) (or fluid injection method) with smaller mass possible. Being the fuel DT or containing DT, the motor layer need neutron protector shield (14) that is too from nanostructured materials, excluding layer (15) from magnets, in this case, because 80% from reaction product particles are neutrons, needing the field only to repel the hot plasma of the first wall (13) from exhaust (13, 14) that already contain nanofluids (13A) that too is the heat exchange (13B) being a safety and light system with smaller mass possible, and being the basic system from FIGS. 8 to 12. In FIG. 9, what change is inside reactor room (16) or reaction vessel, a CPA laser (2) where, for example, laser gun, compressor, amplifier, etc., are made from nanostructured materials. In FIG. 10, inside reactor room (16) has a vessel where all parts and functions are from nanostructured materials (examples table 1) to retain a little nuclear boosted fission explosion, triggered by a laser system (1), like before from nanostructured materials. In FIG. 11, inside reactor room (16) has a contention vessel (2) of explosions from nanostructured material (2N) and z-pinch system or MTF (4) too from nanostructured materials. In FIG. 12, again the more light system, where the laser (1) detonate the nuclear fuel from super high explosive (constituted from nanostructured materials) inside exhaust (13, 14, 15) from nanostructured materials, where the change is in the magnets (15) that is from nanofluids (nano iron fluid, nano crystals of iron), bulk nano magnets (15N), since too much parts of continuation-in-part patent application like sheets or tubes (15A) are from nanostructured materials for magnetic stress contention. In FIG. 13, the z-pinch system and representation of super capacitors bank (4) constituted from nanostructured materials in the technology of electrochemical double layer capacitor (EDLC), and the transmission lines (4A, 4B) too from nanostructured materials, like example, carbon nanotubes that each can transport 20 mA and in packing containing 1014 encapsulated nanotubes, carrying 100 MA/cm², 100 times the current carrying capacity. In FIG. 14, the high flux compression generator constituted from super capacitors bank (4) from nanostructured materials, the transmission lines (4A, 4B) the coils (4C) and the explosives (4D) from nanostructured materials, that has more energy density and more compact than from common materials.

What is claimed is:

1. Propulsion motor, according to claims from U.S. patent application Ser. No. 10/528,225 filed Mar. 18, 2003, and continuation-in-part patent application Ser. No. 11/324,544 filed Jan. 3, 2005, characterized by, the first wall (13) is formed by from carbon nanotubes (13N), the neutron protector layer (14) from carbon nanostructured is associated (fused, linked) to a nanostructured ceramic matrix, the magnets (15) are (Fe,Ni,Co) based nanostructured magnetic materials (15N), the reactor room (16) is formed by nanostructured materials (16N), the two structural cylindrical tubes (17) is formed by carbon nanostructured, the sustentation cylindrical tube (18) contain carbon nanostructured (18N), the structural tubes (17A) are formed by nanostructured carbon.

2. Propulsion motor, according claim 1, characterized in that the neutron protector layer (14) is formed by carbon nanotubes associated (fused, linked) to nanostructured graphite matrix.

3. Propulsion motor, according claim 1, characterized in that the magnets (15) are formed by (Fe,Nd,B) based magnets nanostructured materials (15N).

4. Propulsion motor, according claim 1, characterized in that the magnets (15) is formed by (Cu—C) based magnets nanostructured materials (15N).

5. Propulsion motor, according claim 1, characterized in that the magnets (15) is constituted by magnetic nano fluids (ISA) of (Fe₃O₄) based nano iron fluid (15N).

6. Propulsion motor, according claim 1, characterized in that the reactor room (16) contains carbon nanotubes associated (fused, linked) to glass alloys and super plastic (16N).

7. Propulsion motor, according claim 1, characterized in that the cylindrical tubes (17), (17A) and (18) are formed by nanostructured materials associated to polymers, ceramics (silicon carbide, boron carbide) and metal alloys (Ti, Mo, Al).

8. Propulsion motor, according claim 1, characterized in that the cylindrical tubes (17), (17A) and (18) is formed by nanostructured materials associated to fiber (carbon, Kevlar, nextel).

9. Processes and beams from thermonuclear fusion micro reactions, according to claim 10 of U.S. patent application Ser. No. 10/528,225 and according to claim (8) of continuation-in-part provisional Ser. No. 11/324,544 and above claim 1, characterized in that part of trigger system (1) is formed by nanostructured materials, the contention vessel (reactor) (2) contains nanostructured materials (2N), part of CPA laser system (2) is formed by nanostructured materials, the magnets (3) are (Fe,Nd,B) based nanostructured materials, the z-pinch system (2, 4, 4A, 4B) is formed by nanostructured materials, the high flux compression generator (4, 4A, 4B, 4C, 4D, 4E) is constituted of nanostructured materials, the first wall refrigeration system (13A, 13B, 13C, 13D) is formed by nanostructured materials, containing carbon nanotubes.

10. Processes and beams from thermonuclear fusion micro reactions, according to claim 9, characterized in that the contention vessel (reactor) (2) is formed by materials, mainly carbon nanostructured (carbon nanotubes) (2N) associated (fused, linked) to glass alloys and superplastics.

11. Processes and beams from thermonuclear fusion micro reactions, according to claim 9 characterized in that the z-pinch system (2, 4, 4A, 4B) has electrochemical double layer capacitors formed by carbon nanostructured aerogel (4), transmission lines (4A) formed by encapsulated carbon nanotubes.

12. Processes and beams from thermonuclear fusion micro reactions, according to claim 9, characterized in that the elements of high flux compression generator (4, 4A, 4B, 4C, 4D, 4E) are formed by electrochemical double layer capacitor from carbon nanostructured aerogel (4), transmission lines (4A, 4B) formed by encapsulated carbon nanotubes, the coils (14C) formed by nanostructured magnetic materials, the explosives (4D) formed by super high explosives (SHE), constituted of nanostructured materials.

13. Processes and beams from thermonuclear fusion micro reactions, according to claim 9, characterized in that the amplifier, compressor, laser gun, etc., of CPA laser (2) are formed by nanostructured materials and their optical, mechanical, electrical and thermal properties.

14. Processes and beams from thermonuclear fusion micro reactions, according to claim 9, characterized in that the refrigerator fluid (13A) is formed by nano fluids constituted of water and metal (Cu, etc.) nano particles.

15. Processes and beams from thermonuclear fusion micro reactions, according to claim 9, characterized in that the refrigerator fluid (13A) of nano fluids is constituted of lithium and metal (Cu, etc.) nano particles.

16. Processes and beams from thermonuclear fusion micro reactions, according to claim 9, characterized in that the refrigerator fluid (13A) is formed by nano fluids constituted of water and ceramics nano particles.

17. Processes and beams from thermonuclear fusion micro reactions, according to claim 9, characterized in that the refrigeration system (13B, 13C, 13D) is formed by nanostructured materials associated to polymers, ceramics, metal alloys (Cu, etc.), forming bulk nanostructured materials and their mechanical, thermal and electrical properties.

18. Processes and beams from thermonuclear fusion micro reactions, according to claim 9, characterized in that the refrigeration system (13A, 13B, 13C, 13D) is constituted from only one geometrical object (body) with all functions cited and properties in associations with nanostructured materials, inside and around exhaust vessel (13, 14, 15), become a bulk nanostructured material and their mechanical, thermal and electrical properties.
